(19) United States
(12) Patent Application Publication
(10) Pub. No.: US 2026/0106717 A1
(43) Pub. Date: Apr. 16, 2026

(54) METHODS AND PROCEDURES FOR ORTHOGONAL RADAR COMMUNICATION

(71) Applicant: InterDigital Patent Holdings, Inc., Wilmington, DE (US)

(72) Inventors: Satyanarayana Katla, London (GB); Onur Sahin, London (GB); Rui Yang, Melville, NY (US)

(73) Assignee: InterDigital Patent Holdings, Inc., Wilmington, DE (US)

(21) Appl. No.: 19/359,133

(22) Filed: Oct. 15, 2025

Related U.S. Application Data
(63) Continuation of application No. 18/023,206, now abandoned.
(60) Provisional application No. 63/070,091, filed on Aug. 25, 2020.

(51) Int. Cl. H04L 5/00

(52) U.S. Cl. CPC H04L 5/006; H04L 5/0094

(57) ABSTRACT

Methods and apparatuses for orthogonal radar communication are described herein. A method performed by an Access Point (AP) may include estimating, at a first time instance, a channel frequency response (CFR) for a set of subcarriers; allocating, from the set of subcarriers, based on the estimated CFR, a subset of subcarriers for sensing and a subset of subcarriers for data transmission; and transmitting, to a station (STA), data using the subset of subcarriers for data transmission and information indicating the allocated subset of subcarriers for sensing. The method may further comprise receiving feedback from the STA and allocating, from the set of subcarriers, based on the received feedback, another subset of subcarriers for sensing and another subset of subcarriers for data transmission.

### CROSS REFERENCE TO RELATED APPLICATIONS

This application is a continuation of U.S. patent application Ser. No. 18/023,206 filed Feb. 24, 2023, which is the U.S. National Stage, under 35 U.S.C. § 371, of International Application No. PCT/US2021/047586 filed Aug. 25, 2021, which claims the benefit of U.S. Provisional Application No. 63/070,091, filed Aug. 25, 2020, the contents of which are incorporated herein by reference.

### BACKGROUND

Joint radar and communication systems may be considered a coexistence solution to the ever-increasing demand for spectrum, which may be due to increasing usage of services with high bandwidth requirements and the exponential increase in the number of connected devices. Such joint systems may allow radar and the communication systems to operate in the same bandwidth, without causing too much interference between each other.

### SUMMARY

Methods and apparatuses for orthogonal radar communication are described herein. A method performed by an Access Point (AP) may include estimating, at a first time instance, a channel frequency response (CFR) for a set of subcarriers; allocating, from the set of subcarriers, based on the estimated CFR, a subset of subcarriers for sensing and a subset of subcarriers for data transmission; and transmitting, to a station (STA), data using the subset of subcarriers for data transmission and information indicating the allocated subset of subcarriers for sensing. The method may further comprise receiving feedback from the STA and allocating, from the set of subcarriers, based on the received feedback, another subset of subcarriers for sensing and another subset of subcarriers for data transmission.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of data subcarrier allocation for radar communication;

FIG. 3 shows an example signaling exchange between an AP and a STA during dynamic data subcarrier allocation for sensing;

FIG. 4 is a flowchart of an example orthogonal radar communication using dynamic data subcarrier allocation for data and sensing relying on the channel frequency response;

FIG. 5 illustrates an example of redundant pilots and their positions across a time-frequency grid, depending on the coherence bandwidth, B_{c};

FIG. 6 depicts a message exchange between an AP and a STA during dynamic pilot subcarrier allocation for sensing; and

FIG. 7 is a flowchart (from the perspective of a STA) showing the STA's allocation of pilot subcarriers for sensing.

### DETAILED DESCRIPTION

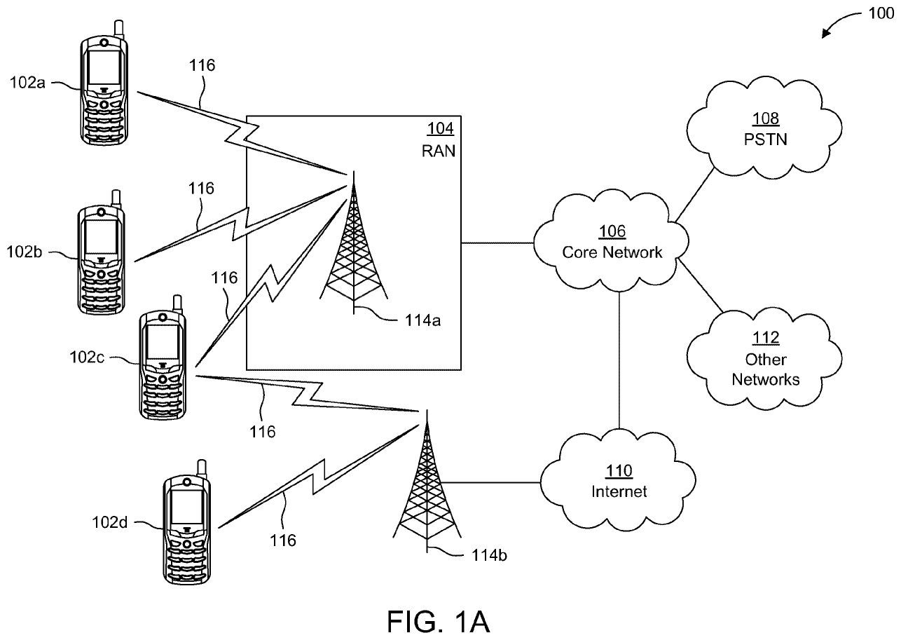

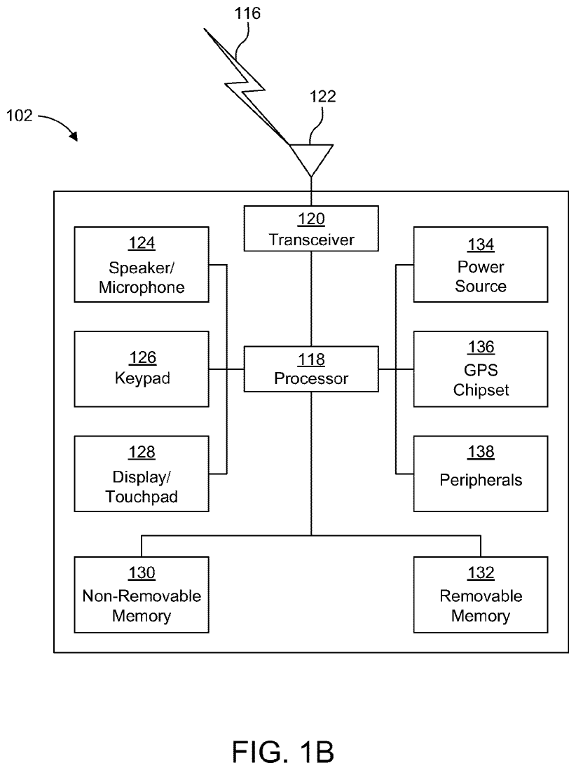

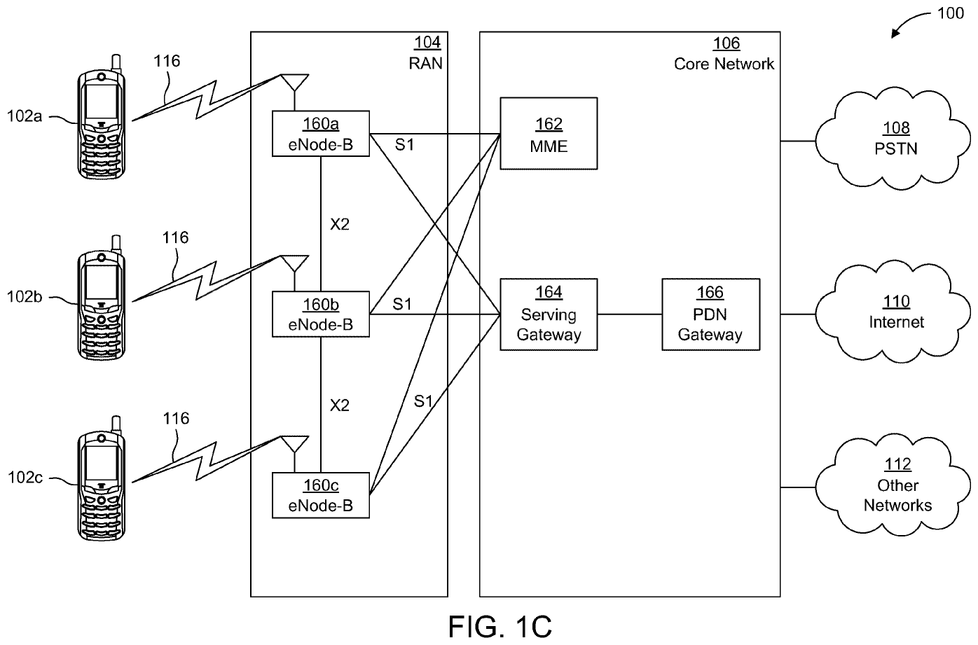

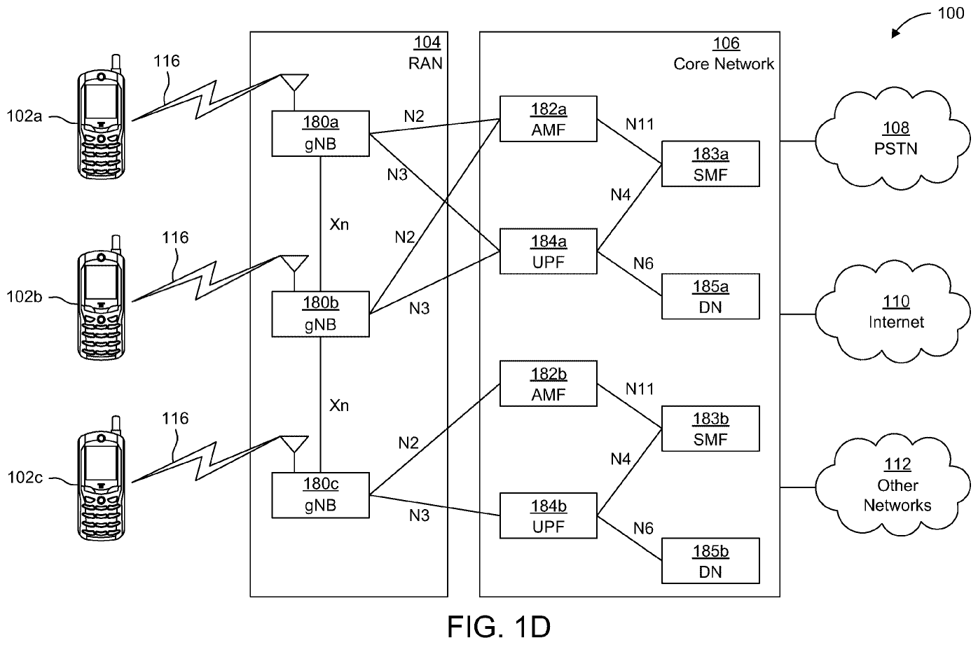

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Disclosed herein are methods and systems for multicarrier joint radar and communication using an underlying communication system (e.g. WLAN), wherein the system may be facilitated with sensing capabilities. Such sensing capabilities may enable, for example, detection of people, monitoring the well-being of a person, localization of a person or device (including coarse and/or fine localization), measuring the velocity of a moving object, and detecting obstacles. Sensing procedures may be enabled by the modifications to the communication system in order to sense and track changes in the environment, and sensing procedures may utilize these changes to infer sensing-related information.

Metrics used for quantifying sensing performance may include, for example, received signal strength indicator (RSSI), channel state information (CSI), angular resolution, range resolution, and time-of-flight (ToF), etc. For instance, the state-of-the-art 802.11 SENS [3] may focus on the CSI metric, since CSI may provide finer granularity, while other metrics (e.g. RSS, ToF) may provide a coarse measure of detection.

The resolution of the CSI for measuring the variations arising from motion due to the Doppler effect, which may be used to determine the motion and/or location of an object, may be dependent on bandwidth. Thus, disclosed herein are procedures for enhancing the bandwidth used for sensing in the context of multicarrier joint radar and communication systems.

Embodiments disclosed herein may consider the context of a wireless communication scenario involving transmit/receive units, e,g, access points (APs), and/or base stations (BSs), where these units possess both data and sensing features relying on multicarrier waveforms (e.g. OFDM). Scenario considered by the disclosed embodiments may include user equipment (UEs), Stations (STAs), where each communicates with one or more associated APs or BSs using a data link. Any of the above devices may be referred to interchangeably as Wireless Transmit/Receive Units (WTRUs). Scenarios considered by the disclosed embodiments may contemplate various objects, moving or static, which are the subject for sensing. Various forms of radar communication performed by the AP or BS, e.g. joint sensing and communication, may be employed by either of two modes: orthogonal, or non-orthogonal transmission. In an orthogonal mode, communication and sensing operations may share the orthogonal resources, such as space, frequency and time; while in non-orthogonal mode, communication and sensing operations may share the same resources.

Embodiments disclosed herein may consider the orthogonal mode of transmission, which may also be the mode of operation discussed in state-of-the-art standardization, including IEEE 802.11 SENS SG. The state-of-the-art solutions proposed for joint sensing and communications may pose one or more challenges.

For example, the data spectral efficiency may be affected if resources, e.g. sub-carriers, are not allocated in sufficient amounts for communications due to over-utilization for sensing applications. On the other hand, limited and non-adaptive, i.e. static, allocation of spectral resources for sensing may affect object detection and sensing performance, including resolution. Furthermore, owing to the sensing sensitivity to CSI fading, the sensing accuracy may be dependent on the choice of specific subcarriers allocated for radar sensing. State-of-the-art solutions, including IEEE 802.11 SENS, may lack the procedures for dynamic allocation of the spectral resources between data and sensing.

To circumvent the above challenges, interplay between sensing and communication in PHY/MAC may prove to be useful. The solutions presented herein may be applicable to any multi-carrier based wireless communication technologies. In order to exemplify the procedures, the embodiments disclosed herein may directly consider an IEEE 802.11 system model and terminology (e.g. AP, STA, PPDU, etc), however, the teachings may be extended to other technologies, such as systems implemented according to Third Generation Partnership Project (3GPP) specifications (e.g., 4G Long-Term Evolution (LTE), 5G New Radio (NR), or other forthcoming specifications) without loss of generality.

Proposed solutions detailed herein may describe methods envisioned for the a device, such as an AP, to enable adaptive sensing procedures whilst ensuring that signaling or transmissions abide by QoS requirements in the data link. Such methods may include: orthogonal radar communication using dynamic data subcarrier allocation for data and sensing that rely on the channel frequency response; and orthogonal radar communication that dynamically leverages the pilot subcarrier of the STA for sensing.

Embodiments directed to adaptive data and sensing subcarrier allocation are described herein, including proposed solutions directed to dynamic data subcarrier allocation for sensing. Sensing performance may be highly sensitive to fading of the channel; therefore, the choice of subcarriers allocated for sensing may determine the accuracy of sensing. Furthermore, facilitating sensing with larger bandwidth may improve the sensing resolution. Considering these factors, embodiments directed to dynamic data subcarrier allocation for sensing are proposed. In such solutions, subcarriers that are congenial for sensing may be selected, while rest of the subcarriers may be allocated for data communication relying on sophisticated adaptive modulation and coding schemes.

Procedures for adaptive data and sensing subcarrier allocation design, as well as enabling and participating devices for such procedures may be summarized as follows. A device, such as an AP, may estimate a channel frequency response (CFR) of N subcarriers using K pilot subcarriers, which may be different for different multiple-input/multiple output (MIMO) schemes in the preamble of a physical layer protocol data unit (PPDU). The device may vary the pilots' location in time (e.g. using rotating pilots), which may be allocated for channel estimation by interpolation. The CFR may be fed back from another device, e.g., a STA, to the AP. The choice of the device for sensing may be based on one or more data transmission requirements. For instance, an AP may choose a STA that does not have high data requirements, such that STA's subcarriers can adaptively be leveraged for sensing.

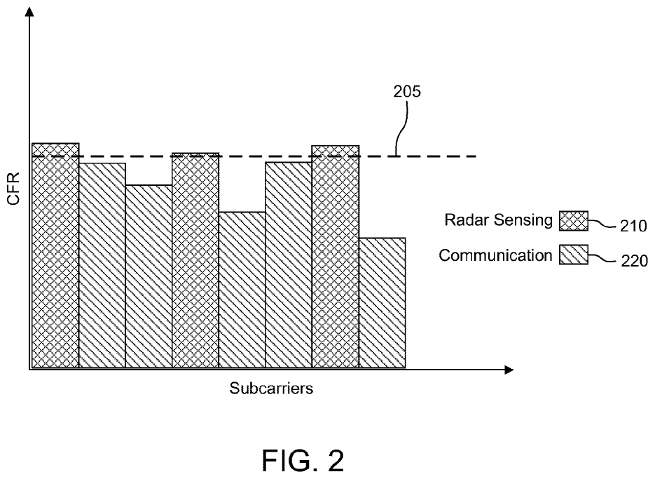

FIG. 2 shows an example of data subcarrier allocation for radar communication. A first device, such as an AP, may select a subset of subcarriers, e.g., Nₛ subcarriers, from a set of subcarriers that are suitable for sensing. Some approaches may account for the sensitivity of radar communication mechanisms when certain subcarriers are used. In such cases, the selection may be based on one or more parameters such as an estimated CFR, as described above. For instance, as shown in FIG. 2, subcarriers 210 for which an estimated CFR satisfies a threshold 205, such as a sensing signal-to-noise ratio (SNR) threshold, may be designated or assigned to be used for sensing. Other subcarriers 220 for which an estimated CFR does not surpass the threshold 205 may be designated or assigned to be used for data communication with an appropriate Adaptive Modulation and Coding (AMC) scheme. The other subcarriers 220 may be determined by the expression N−K−Nₛ. Feedback from another device or devices, such as a STA, may be used instead of, or in addition to, information (e.g., measurements or estimates) obtained by the first device to determine the number of subcarriers that may be assigned or designated for sensing subcarriers with appropriate channel gain (i.e. CFR, as shown in FIG. 2).

The first device (e.g., the AP) may send data to another device (e.g., a STA) using rest of the N−K−Nₛ subcarriers. The AP may receive the feedback from the STA, and if an acknowledgement (ACK) is received, in some cases, the AP may continue to perform sensing by selecting different subcarriers from the set of suitable subcarriers for sensing in a later sensing interval. The later sensing interval may be the next sensing interval, and may be a fixed or variably scheduled packet frame (e.g., a PPDU in Wi-Fi-compliant embodiments). The selection of different subcarrier sets may allow for increased total effective bandwidth for sensing, which may result in better resolution. In the case of an error event (i.e., an ACK is not received), the AP may dynamically adjust the number of subcarriers designated or assigned for sensing (e.g. depending on use the subcarrier requirement suggestion, N_{sg}, from the STA) and choose to allocate more subcarriers to the STA for data communication.

When the subcarrier selection for data and sensing is made and transmitted over the wireless medium, a first device (e.g., an AP) may receive and may aggregate the CFR measurements in some or all transmit/receive intervals (e.g., intervals in which PPDUs are transmitted or received). The aggregated feedback data may be used to determine, infer, or detect information about objects, such as the number of objects, motion of the objects, and/or the size of objects, based on these CFR values.

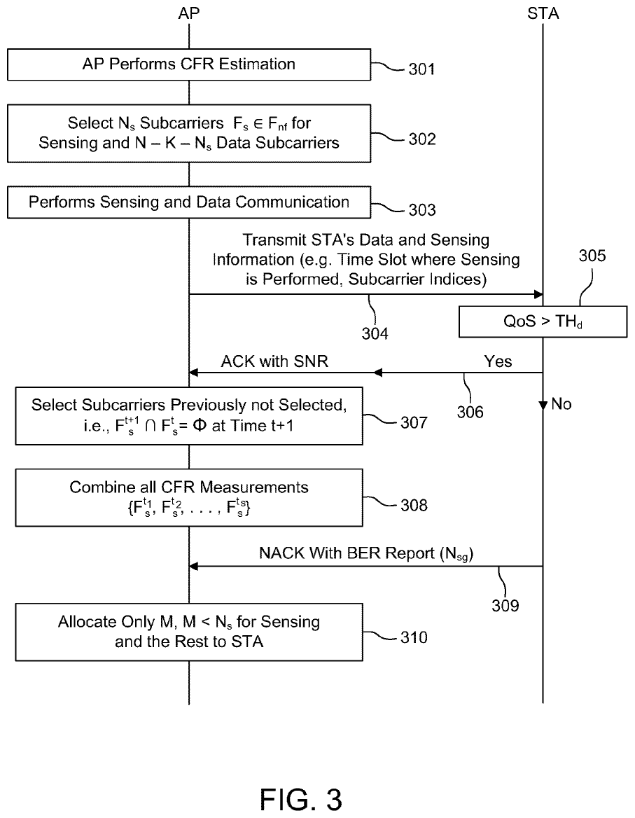

FIG. 3 shows an example signaling exchange between a first device (in this example, an AP) and a second device (in this example, a STA) for dynamic data subcarrier allocation for sensing. Such signaling may enable sensing operation in an underlying communication system, (e.g. systems implementing technologies according to WiFi, 4G LTE, or 5G NR or other technical specifications).

In a given time interval, such as an interval in which a PPDU is transmitted or received, when a sensing mode is activated, as shown at 301, the AP may estimate a CFR of N subcarriers using K pilot subcarriers. As shown at 302, the AP may select Nₛ subcarriers as sensing subcarriers.

Steps 301 and 302 may be performed, for example, substantially as described above with respect to FIG. 2, which illustrates an example of subcarrier allocation for sensing and data. As shown in the example of FIG. 3, sensing may be more sensitive to CFR gain, and in such cases, subcarriers with high CFR may be allocated for sensing while the rest of the subcarriers with appropriate AMC may be assigned to STA or designated for communication.

In some embodiments not explicitly shown in FIG. 3, the selection procedure may depend on a given channel gain threshold value (e.g. TH_{SES}). The sensing subcarriers may be selected among the subcarriers that satisfy the threshold, i.e. F_{nf}={fₐ, . . . , fₘ}, with SNR_{Fnf}>TH_{SES}. In some embodiments not explicitly shown in FIG. 3, the STA may send feedback of the indices corresponding to subcarriers that could be used as sensing subcarriers to the AP. The values Nₛ and TH_{SES} may be decided based on a sensing resolution threshold, channel coherence time, data QoS requirements, or other parameters.

The remaining {N−K−Nₛ} subcarriers may be allocated for data by an AP in the downlink, for instance, with an appropriate MCS and/or PPDU length (e.g., keeping the same MCS and lengthening the PPDU, varying the MCS and maintaining the PPDU length, or maintaining both the MCS and PPDU length). As shown at 303 and 304, the AP may perform sensing and data communication, transmitting data to a STA as well as the sensing information (e.g. indicating a time interval when sensing is performed, and/or indicating a subcarrier index used for sensing, or other information).

At 305, the STA may determine whether a QoS of the data surpasses a threshold value. At 306, if so the STA may send an acknowledgement (ACK), for instance, after every data block. The STA may transmit the ACK, for instance, along with an SNR for the data.

As shown at 307, if the STA sends an ACK in every successive sensing (e.g. PPDU) interval, such as when the QoS of the data received from the AP surpasses the threshold for every data block, the AP may change the subcarriers allocated or designated for sensing and select a new set of Nₛ subcarriers as sensing subcarriers/pilots. This new set may be determined based on the sensing subcarrier scheduling performed in the previous sensing intervals (e.g. PPDUs) which may be part of the same sensing event/application. In some options, for the new sensing subcarriers, the AP may allocate or designate the subcarriers that were not selected for the sensing in the previous PPDUs, i.e.

$${F}_{s}^{\{ t + 1 \}} ∩ {F}_{s}^{\{ t \}} = ∅ ,$$

where t represents a given time. Alternatively or additionally, the AP may select a limited number of subcarriers from among the previously allocated or designated sensing subcarriers, e.g. those used for previous PPDUs, as part of the new sensing subcarrier set

$$( {F}_{s}^{\{ t + 1 \}} ∩ {F}_{s}^{\{ t \}} = ∅ ) .$$

Selection of different subcarrier sets may allow for increased total effective bandwidth for sensing, which may result in better resolution.

At a given time instance, tₛ, an AP may combine the measurements, e.g. CFR, from some or all sensing subcarriers over which PPDUs were previously transmitted, i.e.

$$\{ {F}_{s}^{\{ t \}} , {F}_{s}^{\{ t + 1 \}} , … , {F}_{s}^{{t}_{s}} \}$$

to obtain high resolution sensing information, shown at 308. Nₛ may be adapted dynamically in every iteration (i.e., every value of t) depending on the MCS/QoS requirements of the STA.

In some scenarios as shown at 309, for instance, if the data QoS threshold or requirement is not met at the STA, which may occur in case of an error event, the STA may send a negative acknowledgement (NACK), a BER report, and/or the number of subcarriers suggested and/or requested, N_{sg}, for downlink data. In some options, the STA may send subcarrier IDs that could be used for the data transmission in the downlink and/or the subcarrier IDs that are suitable for sensing operations. Then, as shown at 310, the AP may reduce the number of sensing subcarriers to M, where M<N, and increase the subcarriers for data to {N−K−M} during the specific sensing interval, depending on factors such as the QoS requirement, which may refer to a BER, SNR, or another metric, or other network parameters.

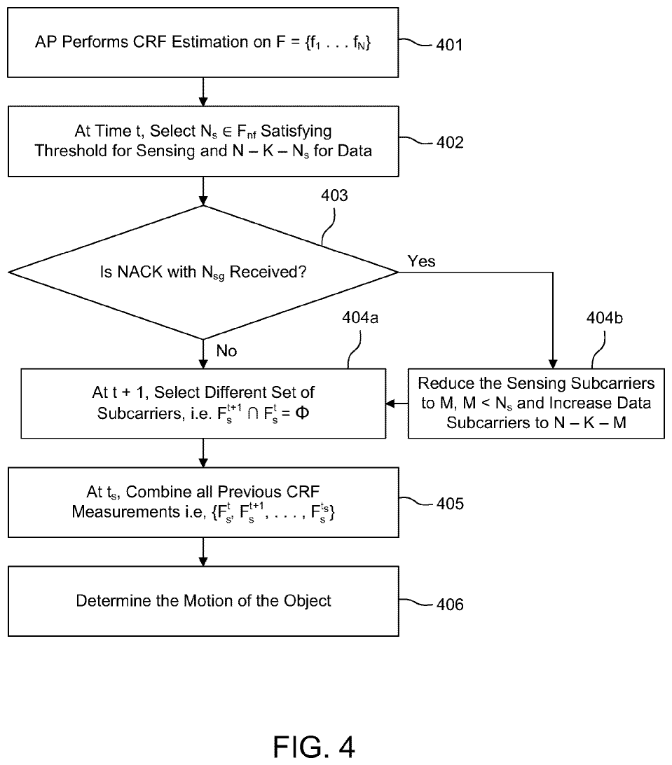

FIG. 4 is a flowchart of an example orthogonal radar communication using dynamic data subcarrier allocation for data and sensing relying on the channel frequency response. As shown in FIG. 4 at 401, a device (e.g., an AP) may estimate a CFR for a set of subcarriers F={f₁, . . . , f_{N}}, where N represents the total number of subcarriers. At 402, at a given time t, the AP may select a subset of subcarriers Nₛ∈F_{nf} from the set, where each of the selected subcarriers have an estimated CFR that exceeds a threshold value. The AP may also select another set of subcarriers {N−K−Nₛ} to be subsequently used for data communication. Sensing and data communication may be performed using the respectively designated sets of subcarriers.

As shown at 403, the AP may determine a course of action based on a received response (e.g., a response received from a STA in communication with the AP). For instance, as shown at 404b, if a NACK (which may indicate, for instance, that data communication over one or more of the designated data subcarriers failed to meet a required QoS) and/or a number of requested or suggested subcarriers for data communication are received, the AP may reduce the number of subcarriers used for sensing, M, such that M<N, and increase the number of subcarriers designated for data to N−K−M. At 404a, if a NACK is not received, the AP may subsequently, e.g., at t+1, select a different set of subcarriers represented by

$${F}_{s}^{\{ t + 1 \}} ∩ {F}_{s}^{\{ t \}} = ∅ .$$

The steps shown at 404a and 404b may be performed in an interchangeable sequence such as when no NACKs are received for a first selected set of subcarriers, but then a NACK is received for a different selected set of subcarriers. In some scenarios, no NACKs are received and step 404b is not performed.

As shown at 405, at a later time tₛ, the AP may combine all of the previous CFR measurements

$$\{ {F}_{s}^{\{ t \}} , {F}_{s}^{\{ t + 1 \}} , … , {F}_{s}^{{t}_{s}} \} ,$$

and at 406, determine the motion of one or more sensed objects based on the combined CFR measurements. It should be noted that in some embodiments not illustrated, the CFR measurements may not be combined.

Embodiments directed to adaptive and low-overhead pilot subcarrier allocation for sensing are described herein. Such embodiments may include dynamic pilot subcarrier allocation for sensing. To reduce the overhead for data when sensing is jointly employed, the pilot subcarriers of a device (e.g., a STA) may be leveraged for sensing. The number of subcarriers that may be utilized for sensing may depend on a number of redundant pilot subcarriers, which may be contingent on the coherence bandwidth B, of the channel. The redundant pilot subcarriers may be non-essential subcarriers where the STA can perform CFR estimation without utilizing them. The number of redundant subcarriers may become predominant if the channel coherence bandwidth is large. That is, in the presence large coherence bandwidth, it may be that only a few essential pilot subcarriers are required for capturing the CFR, and additional pilot subcarriers used for CFR estimation may be redundant. As discussed substantially above, facilitating sensing with larger bandwidth may improve the sensing resolution; therefore, having more redundant pilot subcarriers in each sensing interval may increase the effective bandwidth for sensing resolution.

Considering these factors, some solutions may involve using a dynamic pilot subcarrier allocation for sensing, where the redundant pilot subcarriers are selected, while rest of the pilot subcarriers are used for channel estimation for data communication at the STA.

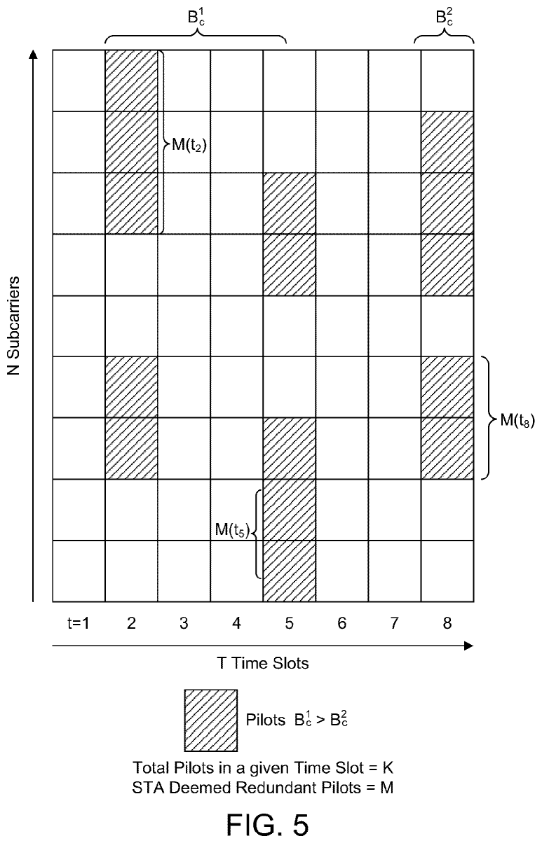

FIG. 5 illustrates an example of redundant pilots and their positions across a time-frequency grid, depending on the coherence bandwidth, B_{c}. The grid may include a resource block of N subcarriers and T time slots depicting the position of K pilot signals transmitted at different time slots with varying number of redundant pilots M depending on the coherence bandwidth B_{c}. As shown in FIG. 5, there may be three redundant pilot carriers at time slots 2 and 8, corresponding to

$${B}_{c}^{1} ,$$

while there may be two redundant pilot carriers at time slot 8 corresponding to

$${B}_{c}^{2} .$$

A “slot” here may be understood as a set of OFDM symbols in time with a fixed size or a predefined variable size.

An example of procedure and enablers according to the proposed solutions may be summarized as follows. A first device (e.g., an AP) may send pilots periodically with a predefined density (frequency), i.e. on K pilot subcarriers out of total N subcarriers. A second device (e.g., a STA)may transmit a CSI report (for example, indicating PMI) as feedback, which may include the indices of the redundant pilot subcarriers at slot i, M(tᵢ) identified for sensing. These M(tᵢ) redundant subcarriers may be used for sensing by the AP. This may be a key enabler for sensing using pilot subcarriers. In a next CSI training slot, tᵢ, the AP may send CSI pilots on the remaining K−M(tᵢ) pilot subcarriers, and may allocate M(tᵢ) for sensing. In some options, a STA may send the changed value of M(tᵢ₊₁), at time slot tᵢ₊₁ depending on the new coherence bandwidth, as well as PMI.

Upon receiving the sensing signals and reflections, the AP may combine some or all the CFR measurements obtained using pilot subcarriers for determined the sensing metric (e.g. motion detection).

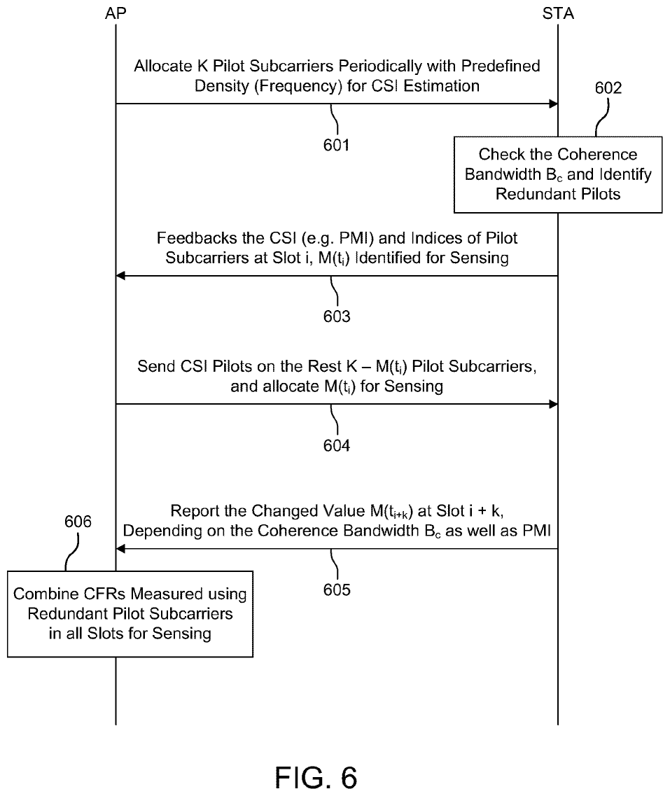

FIG. 6 depicts a message exchange between an AP and a STA during dynamic pilot subcarrier allocation for sensing. An example of a step-by-step procedure according to FIG. 6 may be delineated as follows. As shown at 601, in a given transmit slot i with a total of N subcarriers, a first device (e.g., an AP) may allocate K pilot subcarriers for CSI estimation in the DL channel and the rest of the subcarriers for data transmission. The AP may send information indicating the allocation of the subcarriers to a STA.

As shown at 602, another device (e.g., a STA) may perform CSI estimation using the K pilot subcarriers. The STA may check the coherence bandwidth B_{c} and identify redundant pilots. For instance, if, based on the STA's CSI estimation, the channel coherence bandwidth B_{c} is larger than a given threshold value, the pilot density may be reduced. For example, in the case of a high coherence bandwidth, a lesser number of pilots may suffice for CSI estimation. A new pilot density allocated for CSI may be determined based on B_{c} as well as the required accuracy of the CSI estimation.

In some solutions, as shown at 603, the STA may select M(tᵢ) pilot subcarriers deemed redundant for the CSI estimation at time tᵢ and transmit the information as feedback, including subcarrier indices, to the AP. The AP may use these specific M subcarriers for sensing, e.g. by allocating them as sensing subcarriers. In some solutions, the AP may determine M(tᵢ) subcarriers to be allocated as sensing subcarriers based on coherence time information and the CSI pilot feedback received from the STA. As shown at 604, the AP may send CSI pilots on the rest (or remaining) K−M(tᵢ) pilot subcarriers, allocating the M(tᵢ) subcarriers for sensing.

The number, M(tᵢ), and positions of the subcarrier pilots selected for sensing by the STA may be different in each slot, for example, as shown in FIG. 5, by M(t₂) and M(t₈)). The value of M(tᵢ) may depend on coherence bandwidth and desired sensing resolution.

As shown at 605, the STA may report a changed value of M(tᵢ₊ₖ) at slot i+k, depending on the coherence bandwidth B_{c} as well as PMI. At a given time, tₛ, depicted, for example, at 606, an AP may combine the measurements from sensing subcarriers that were used to transmit previous PPDUs. By combining the subcarriers across T different time slots with M(tᵢ) selected pilots subcarriers in each slot i, the AP may attain a high sensing resolution due to effectively increased bandwidth of M(t) subcarriers.

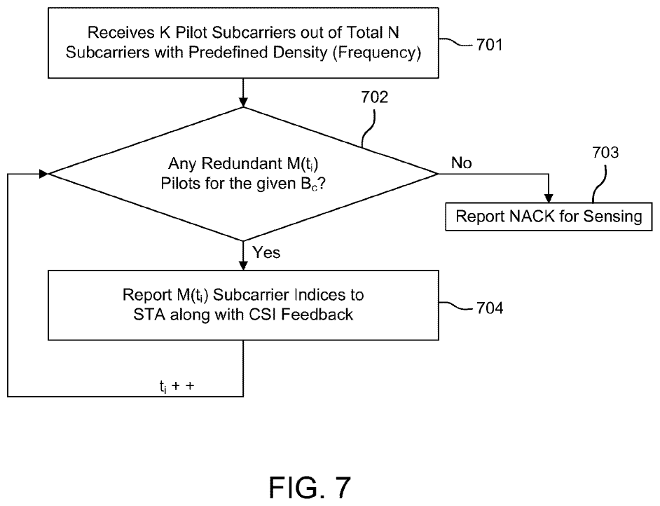

FIG. 7 is a flowchart showing a STA's allocation of pilot subcarriers for sensing, as viewed from the perspective of the STA. As shown, the pilot subcarriers of the STA may be dynamically leveraged for sensing. At 701, the STA may receive, from another device such as an AP, information allocating K pilot subcarriers out of a total of N subcarriers with a predefined subcarrier density. At 702, the STA may identify any redundant pilot subcarriers M(tᵢ) for a given coherence bandwidth B_{c}. If there are no redundant pilot subcarriers, at 703, the STA may transmit a NACK to the AP for sensing. If there are redundant pilot subcarriers, as shown at 704, the STA may report indices for the redundant pilot subcarriers M(tᵢ) to the AP along with CSI feedback for the pilot subcarriers determined at time tᵢ. In subsequent time periods tᵢ₊₊, the STA may again evaluate whether there are redundant pilot subcarriers allocated to the STA and either report a NACK if there are no redundant pilot subcarriers, or the indices of the redundant pilot subcarriers along with the CSI feedback.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for use in an access point (AP), the method comprising:
estimating, at a first time instance, a channel frequency response (CFR) for a set of subcarriers;
allocating, from the set of subcarriers, based on the estimated CFR, a subset of subcarriers for sensing and a subset of subcarriers for data transmission;
transmitting, to a station (STA), data using the subset of subcarriers for data transmission and information indicating the allocated subset of subcarriers for sensing;
receiving feedback from the STA; and
allocating, from the set of subcarriers, based on the received feedback, another subset of subcarriers for sensing and another subset of subcarriers for data transmission.
